(19) United States
(12) Patent Application Publication
(10) Pub. No.: US 2008/0279222 A1
(43) Pub. Date: Nov. 13, 2008

(54) DISTRIBUTION OF TRAFFIC ACROSS A COMPUTER NETWORK

(75) Inventors: Vincent A. Fuller, Palo Alto, CA (US); Michael Slocombe, Acton, MA (US); Matthew Miller, Plainville, MA (US)

Correspondence Address: HENSLEY KIM & HOLZER, LLC, 1660 LINCOLN STREET, SUITE 3000, DENVER, CO, 80264, US

(73) Assignee: Level 3 Communications LLC, Broomfield, CO (US)

(21) Appl. No.: 12/178,498

(22) Filed: Jul. 23, 2008

Related U.S. Application Data
(63) Continuation of application No. 09/978,768, filed on Oct. 18, 2001.

(51) Int. Cl. H04J 3/08

(52) U.S. Cl. 370/501

(57) ABSTRACT

A system and method of distributing traffic across a computer network is provided using a relay apparatus. A relay apparatus includes an interface to a communication network, a data store, and a processor. The data store includes data elements associating a first network address of a server to a second network address of the server. The processor is configured to receive a request corresponding to a data element in the data store, use the data element to determine a corresponding server, and forward the request to the server in a manner such that any response to the forwarded request is sent to the relay apparatus.

### TECHNICAL FIELD

This invention relates to the distribution of traffic across a computer network.

### BACKGROUND

Large Internet Service Providers (ISPs) maintain their own networks with backbones stretching from coast to coast. Because no single major ISP controls the market, it is beneficial for the major ISPs to interconnect their networks, so that users perceive that they are interacting with a single, transparent network. Typically, the interconnections are based on a combination of public multi-access facilities (e.g., MAE-EAST, MAE-WEST) and private point-to-point connections between routers controlled by two respective providers.

Traffic delivered from a customer of an ISP to a destination that is not on the ISP's network traverses an end-to-end path that includes three segments: (1) a segment from the ISP's customer through the ISP's network; (2) a segment represented by the interconnection between the ISP and a target ISP that serves the destination; and (3) a segment across the target ISP to the destination. To reduce congestion, it is often desirable to build both a network and a service model that reduces bottlenecks on all three of these path segments.

An ISP may only have direct control over bandwidth in the first component, while being dependent on the target ISP partially with respect to the second and entirely with respect to the third segment. An ISP may reduce these dependencies by implementing a “local delivery” or “best exit”-like service model that engineers end-to-end paths utilizing the ISP's own network as much as possible.

Traffic between one ISP and another ISP may be exchanged in what is known as “shortest-exit” manner. Under “shortest exit”, traffic originating from one ISP's customer (the source) that is destined for another ISP's customer (the destination) is sent toward the topologically closest interconnection point between the source and the destination. Where the source and destination are not geographically or topologically close to each other, the result tends to be higher costs borne by the destination's ISP. If a first ISP has only large content sites as customers and a second ISP provides only connectivity to content consumers, the cost differences may be so high that it is not in the interest of the second ISP to interconnect at high speed with the first ISP.

Consider traffic sent by a customer, whose content is hosted in a data center in San Jose, Calif., by the “ABC” ISP, across the “XYZ” ISP to a destination located in Washington, DC. Assume that ABC and XYZ can exchange traffic in two locations: one near San Jose, Calif., and the other near Washington, DC. Network traffic flows as follows: (1) a Washington-based customer of XYZ sends a request a short distance across the XYZ network to the interconnection point near Washington; (2) the request enters the ABC network near Washington and is carried a long distance across the ABC network to the San Jose data center; (3) a reply is created by the content server in the San Jose data center and is sent across a short distance on the ABC network to the nearest interconnection point near San Jose; and (4) the reply is carried a long distance across the XYZ network from the San Jose area to the customer in the Washington area.

The traffic flow is asymmetric, with the ABC network carrying the content request and the XYZ network carrying the content reply. Because content replies are typically far larger than content requests (often, by many orders of magnitude—for example, a 100-or-so-byte request can easily result in a multi-megabyte JPG image being returned), the result is greater bandwidth use on the XYZ network and thus greater cost to its ISP.

Referring to FIG. 1, an end user 1010 located near San Jose, Calif., may connect to the Internet through an ISP “A” San Jose point-of-presence (POP) 1020. ISP A also may provide interconnections to one or more other networks, for example, the ISP B San Jose POP 1030. In addition to interconnections with other providers, ISP A may maintain a wide area network (WAN) 1040 to provide connections between various POPs of ISP A that are distributed across the country. In FIG. 1, ISP A WAN 1040 and ISP B WAN 1050 interconnect San Jose and Washington, DC POPs. ISP B DC POP 1060 provides a network connection for web server 1070 as well as an interconnection with the ISP A DC POP 1080.

The network structure shown in FIG. 1 is a simple example of a network architecture connecting two national ISPs. Other more complex implementations could be provided.

Referring to FIG. 2, packets from end-user 1010 to web server 1070 are often routed asymmetrically. In other words, packets sent from end user 1010 to web server 1070 may take a different path than packets sent from web server 1070 to end user 1010. For example, if end user 1010 requests a web page from web server 1070, the request is routed through ISP A San Jose POP 1020. Routers at the San Jose POP maintain routing tables describing how to route packets based on the destination address. In order to simplify routing table information, networks are typically aggregated. For example, ISP B may be assigned the network address 192.168.x.x. The subnet address 192.168.1.x may be selected for the ISP B DC POP 1060 while 192.168.2.x may be selected for the ISP B San Jose POP 1030. Instead of advertising routes to both 192.168.1.x through DC and 192.168.2.x through San Jose, the routes likely will be aggregated so that both POPs advertise a single 192.168.x.x route, thus decreasing the size of routing tables that must be maintained.

Because the ISP B San Jose POP 1030 advertises routes to ISP B DC POP 1060 networks, the ISP A San Jose POP 1020 routes a request from end user 1010 to web server 1070 through the ISP B San Jose POP 1030. The request travels across ISP B WAN 1050 to the ISP B DC POP 1060 and then to web server 1070.

A reply sent from web server 1070 to end user 1010 will likely take a different route as described in FIG. 2. Because the ISP A DC POP 1080 advertises a route to the network used by end user 1010, packets are routed from web server 1070 through ISP B DC POP 1060 to ISP A DC POP 1080. Then, the reply travels across ISP A WAN 1040 to the ISP A San Jose POP 1020 to end user 1010.

Packets sent from end user 1010 to web server 1070 travel most of the distance across ISP B WAN 1050 and packets sent the other direction travel most of the distance across ISP A WAN 1040. Thus ISPs supporting large numbers of end users (e.g., ISPs engaged in server co-location and web hosting) end up carrying a greater portion of transmitted information than ISPs supporting mostly information suppliers. Connecting customers that are large traffic sources to POPs that are not close to the interconnection points may trigger a need for additional backbone capacity.

Costs of interconnection can be reduced by keeping traffic sources topologically close to the points where connections to other ISPs are located, because the bulk of traffic originating at those sources is usually headed toward destinations on other ISP's networks. Keeping the sources close to the exit points reduces the number of links on the backbone that the traffic must cross and therefore reduces the cost of transporting the traffic. Traffic exchange arrangements between ISPs typically have been based on three principles. First, networks are interconnected at multiple, geographically-diverse points, typically including at least one point on the East Coast and one point on the West Coast, in the case of the United States. Second, routing information exchanged at the interconnection points should be identical. Third, network traffic is routed using a “closest-exit” or “hot-potato” approach (i.e., traffic is routed through the topologically-closest exit point on the source ISP's network).

These arrangements place the bulk of the burden of distributing traffic across long distances on the receiver of the traffic. ISPs which are sources of data (i.e., which house large web farms) tend to have much lower costs than those that connect large numbers of data consumers (i.e., those with lots of dialups or other end-users) because, on average, they carry traffic much shorter distances.

The “closest-exit” cost model is easy to implement and reasonably fair, as long as the providers involved are of approximately the same size, exchange roughly the same amount of traffic in each direction, assume comparable costs, and derive comparable benefits from the interconnection arrangement. As the Internet has grown and the market has become somewhat divided into data producers (principally, web-hosting) and consumers (those which connect end users), the larger ISPs are recognizing that being on the receiving side of a traffic imbalance drives up costs without increasing revenue. The result is that larger ISPs resist establishing or expanding interconnections with large data sources.

One way to address the imbalance is to configure the routing system to exchange more detailed routing information (in technical terms, use of “more specifics” and “multiple-exit” discriminators), a step that may effectively disable classless inter-domain routing (CIDR) route aggregation between networks and/or may make ISPs susceptible to malicious behavior by other ISPs.

### SUMMARY

In one general aspect, a relay apparatus is provided. The relay apparatus may include an interface to a communication network, a data store including data elements, and a processor. Each data element associates a first network address of a server with a second network address of a server. The processor is configured to receive a request corresponding to a data element in the data store, use the data element to determine a corresponding server, and forward the request to the server in a manner such that any response to the forwarded request is sent to the relay apparatus.

The request may be received from an originating device with the processor configured to receive a response to the forwarded request and to forward the response the originating device.

The communication network may include one or more from following: a fiber optic network, a land-line network, a wireless network, a cable network, a telephone network, a local area network (LAN), a wide area network (WAN), an Ethernet network, an Internet Protocol (IP) network, a satellite network, an asynchronous transmission mode (ATM) network, and a frame relay network. Network addresses may be an anycast address, Internet protocol (IP) addresses, or an unicast addresses.

Additionally, the server may be a web server, a news server, or any other content-providing device. The relay device may provide caching capabilities to reduce network utilization between the relay apparatus and servers.

In another general aspect, an apparatus is provided including a server, a first point of presence, a second point of presence, and one or more relay devices. Each relay device is configured to receive a request from an originating device, forward the request to the server, receive a reply from the server, and forward the reply to the originating device, such that a reply to a request received through the first point of presence is forwarded to the originating device through the first point of presence and a reply to a request received through the second point of presence is forwarded to the originating device through the second point of presence.

Relay devices may include a web relay device configured to receive and forward hypertext transport protocol (HTTP) traffic. The server may be a web server or any other content-providing server. Additionally, the relay devices may include a cache component.

In another general aspect, a method may be provided including assigning a first address and a second address to a server, and assigning the first address to a relay group. The relay group may include one or more relay devices configured to forward a request sent to the first address to the second address such that any reply returned by the server is routed symmetrically with respect to the request. The addresses may be anycast addresses, Internet protocol (IP) addresses, and/or unicast addresses.

The details of one or more implementations are set forth in the accompanying drawings and description below. Other features and advantages will be apparent from the description and drawings, and from the claims.

### DESCRIPTION OF DRAWINGS

FIG. 1 shows a computer network.

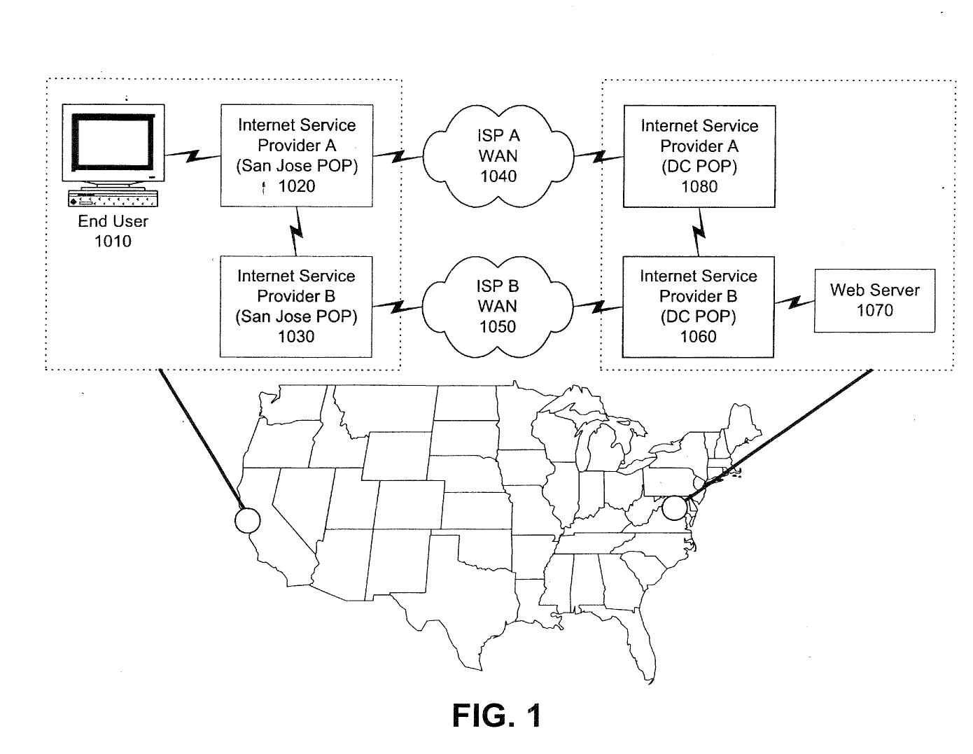

FIG. 2 shows an asymmetrical routing sequence.

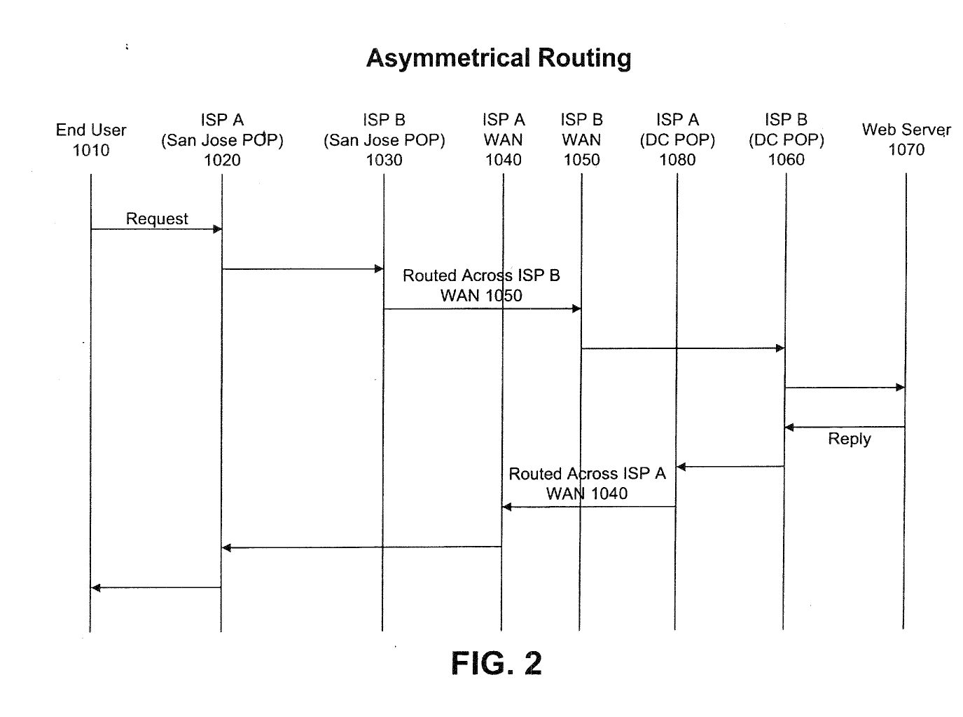

FIG. 3 is a diagram of a symmetrical routing sequence for a request by an end user to a web server and the return response.

FIG. 4 is a diagram of an exemplary network architecture showing an end user and a web server connected to the Internet.

FIG. 5 is a block diagram of an exemplary implementation for scaling high-bandwidth data sources on a computer network.

FIG. 6 is a block diagram of a provider network with multiple points-of-presence using web relays to scale high-bandwidth data sources.

FIG. 7 is a block diagram of a provider network with end users attached using web relays and anycast addresses to scale high-bandwidth data sources.

FIG. 8 is a flow chart of packet routing in an exemplary implementation of a system for scaling high-bandwidth data sources.

### DETAILED DESCRIPTION

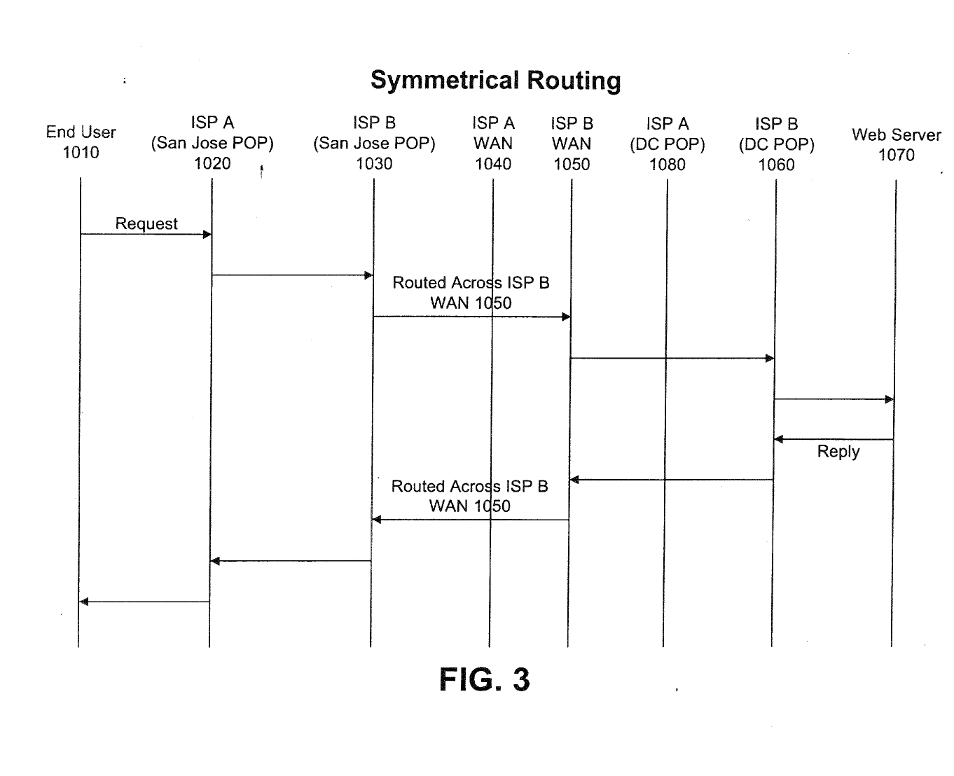

Referring to FIG. 3, in a symmetrical routing system 1008, packets sent from end user 1010 to web server 1070 and packets sent from web server 1070 to end user 1010 traverse the same networks. For example, a request for a web page by end user 1010 is sent through ISP A San Jose POP 1020 to ISP B San Jose POP 1030. The request is then routed over ISP B WAN 1050 to ISP B DC POP 1060. Finally, the request is sent to web server 1070. A reply is sent from web server 1070 through ISP B DC POP 1060 across ISP B WAN 1050 to ISP B San Jose POP 1030. Then, the reply is routed through ISP A San Jose POP 1020 to end user 1010. Thus, the packet is symmetrically routed with respect to the logical entities described in FIG. 3.

Symmetrical routing, as described in FIG. 3, does not mean that there is no asymmetry. For example, ISP B WAN 1050 may include two T1 connections between DC and San Jose with ISP B's routers configured to distribute load between the two T1 connections by round-robin-ing between them. In this case, the routing may have some asymmetries; however, with respect to ISP A and ISP B, the routing between them is symmetrical, in that the request and response traffic crosses the same interconnection point between the ISPs.

By making routing more symmetric, content-providing ISPs gain greater control over traffic control and bandwidth utilization. ISPs may make routing more symmetric by introducing active content processing devices, called “web relays,” to engineer desired traffic flows. A web relay is a device that accepts requests for content, retrieves that content from an “origin server”, and then relays the content to the original requester. A web relay is similar to a web cache except that a web cache keeps copies of cacheable content it retrieves from origin servers so that future requests for the same content may be satisfied without again consulting the origin server.

Referring again to the example discussed above, a web architecture may be redesigned by inserting web relays between a request originator and a content location to engineer the traffic flows. Revisiting the example described above, the revised traffic flow is roughly as follows: (1) the XYZ customer sends a request, which is sent a short distance across the XYZ network to the interconnection point near Washington; (2) the request enters the ABC network near Washington and is initially processed by a web relay in the Washington area; (3) the web relay in the Washington area initiates a new request for the content and transmits it across the ABC backbone to the content server in the San Jose data center; (4) a reply is created by the content server in the San Jose data center and sent back to the web relay in the Washington area; (5) the web relay in the Washington area takes the reply it receives and uses it to satisfy the original user request; and (6) the reply is carried a short distance across the XYZ network to the original requester. Because both the data center and the web relay are internal to the ABC network, this traffic travels long distance across the ABC backbone.

In this example, traffic flow is symmetric between the content requestor and content source and is kept on the “source provider” network as much as possible. The result is reduced backbone utilization (and, thus, cost) for the ISP of the content-consuming customer, which should make providing interconnection capacity more attractive for that ISP. This, of course, means increased backbone utilization (and cost) for ABC but also provides better control over end-to-end bandwidth capacity. And if the ABC backbone network is superior in capacity and cost, improved performance as well as lower overall system cost will result (the total cost to both ABC and the other ISP).

Additionally, web relays may be used to keep traffic on an ISP's backbone as much as possible. Such routing provides an ISP a greater ability to control bandwidth and performance for its customers. By keeping traffic on its backbone, an ISP may be able to increase performance for both content-consuming customers and content-providing customers.

The web relay in this context may or may not actually cache content. Its primary function is to act as a “content relay” and ensure that traffic flows across the ABC network; where caching of the relayed content is possible (i.e., for static content and content which is not time-sensitive or otherwise not amenable to caching). Keeping copies local to the web relay can reduce load across the backbone.

In order for the web relays to perform their relaying function, web requests should be sent to the relays instead of the ultimate content sources. While it is possible to configure routers to redirect web traffic toward a web relay, doing so tends to increase layer-3 switching load and complexity.

A simpler approach may be used by assigning a special “anycast” address to a set of web relays that provide service for a particular content source. An anycast packet is one that should be delivered to one member in a group of designated recipients (e.g., the closest recipient in the group). Public domain service for the content source URLs (i.e., “www.company.com”) is then configured to point to this anycast address. Shortest-exit routing of content requests will automatically cause the anycast addresses to be handed-off to the content-hosting provider web relay that is closest to the interconnection point.

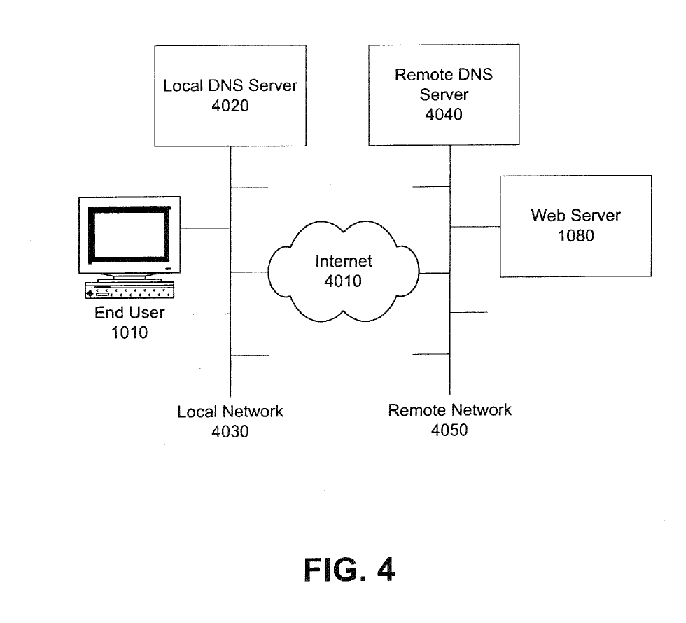

Referring to FIG. 4, a network configuration may include an end user 1010 that sends requests for information across the Internet 4010 to various servers, for example, web server 1080. Typically, end user 1010 refers to web servers located across the Internet 4010 using a hostname, such as, “www.company.com”. Internet hosts are identified on a computer network by an address that is typically an Internet protocol (IP) address. The domain name service (DNS) is typically used to translate hostnames into IP addresses. For example, local DNS server 4020 is accessible by end user 1010 across local network 4030. When end user 1010 requests a web page, such as “www.company.com”, the system typically queries local DNS server 4020 to translate the hostname to an IP address. For remote hosts, the local DNS server 4020 may send a request to one or more remote DNS servers 4040 on a remote network 4050 to satisfy the request.

In order to reduce the asymmetry of routing, it is desirable to force responses from information requests back through the same wide area network that the information request traversed. One way to do this is to inject a level of indirection into the system. Because ISPs typically use a “shortest-exit” routing policy, the requests usually enter a content-provider's network at a POP closest to the requesting host. It is desirable to provide a system whereby responses to information requests are routed through the same POP that the information request entered the network such that the exit point from the content provider's network is close to the end user 1010.

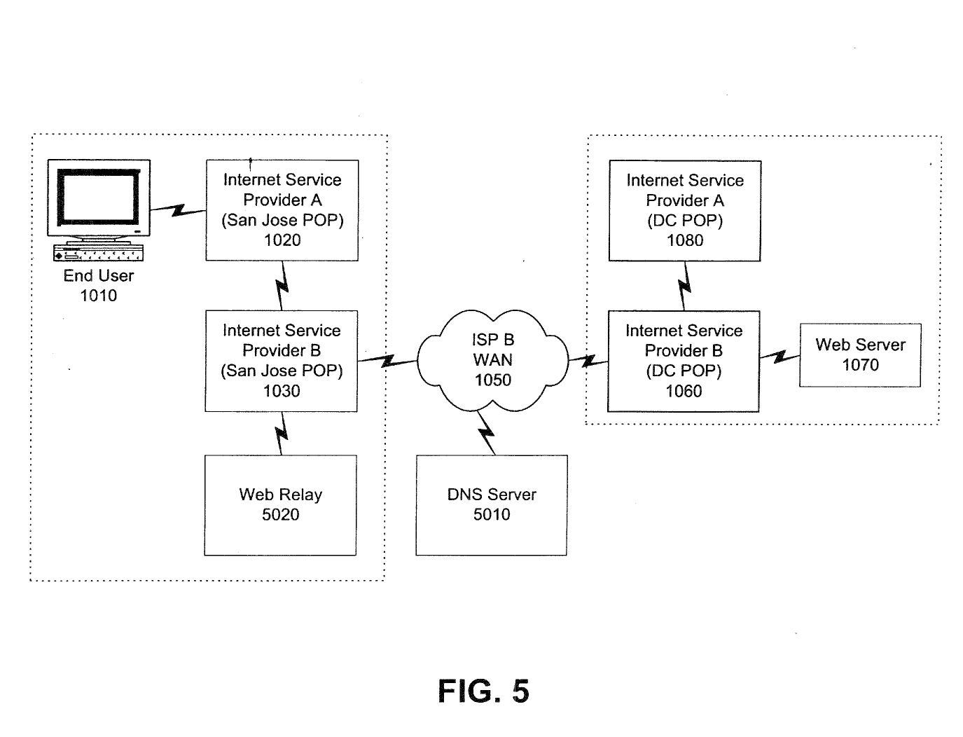

Referring to FIG. 5, end user 1010 connects to ISP A San Jose POP 1020 using a network connection. For example, end user 1010 may connect using any available network interface device, such as, a cable modem, a wireless network interface card, a modem, an Ethernet network interface card, or a fiber optic network interface card. Packets destined for web server 1070 are routed through ISP B San Jose POP 1030. To ensure that response packets are returned through ISP B San Jose POP 1030, a web relay 5020 may be used.

Web relay 5020 receives information requests destined for web server 1070 and relays those requests across ISP B WAN 1050 to ISP B DC POP 1060. Finally, the request is sent to web server 1070. Without the use of web relay 5020, response packets would enter ISP A's network at ISP A DC POP 1080. However, when web relay 5020 forwards requests to web server 1070, web relay 5020 is identified as the source of the request. Thus, the response is initially sent back to web relay 5020 across ISP B WAN 1050.

Internet Requests for Comment (RFCs) that describe implementations of anycast addresses include: RFC 2372 (July 1998), RFC 1546 (November 1993), RFC 2373 (August 1999), and RFC 2526 (March 1999), all incorporated by reference.

As described in RFC 2373, an anycast address may include a subnet prefix identifier and an anycast identifier. The subnet prefix may be used to specify the network providing the anycast addresses. The anycast identifier is used to specify one of many possible anycast addresses on a particular subnet. A unicast address, or conventional IP address, specifies a single interface on a computer network. In contrast, an anycast address may specify more than one interface. For example, anycast addresses may be used to specify a group of one or more servers on a computer network. These servers may provide a redundant service. Routers forward packets destined to anycast addresses to the closest anycast destination for a particular address. Thus, anycast addresses provide a way to distribute load across one or more servers such that traffic from a requestor is routed to the server closest to that requestor.

As shown in FIG. 5, web relay 5020 receives requests destined for web server 1070 and relays those requests on to the server. One way to implement this behavior is to configure DNS server 5010 to return an anycast address for web server 1070. Web relay 5020 may be assigned the anycast address associated with web server 1070. Then, packets sent to that anycast address will be routed to web relay 5020. Web relay 5020 then translates the anycast address into a unicast address or other address corresponding to web server 1070.

A web relay may include functions that are effectively a subset of those of a web cache; thus, a web cache may be used to implement a web relay. However, in the context of this design, a web cache deployed as a web relay must be aware that requests are received on an anycast address but are satisfied by queries to origin servers using the relay/cache's unicast address.

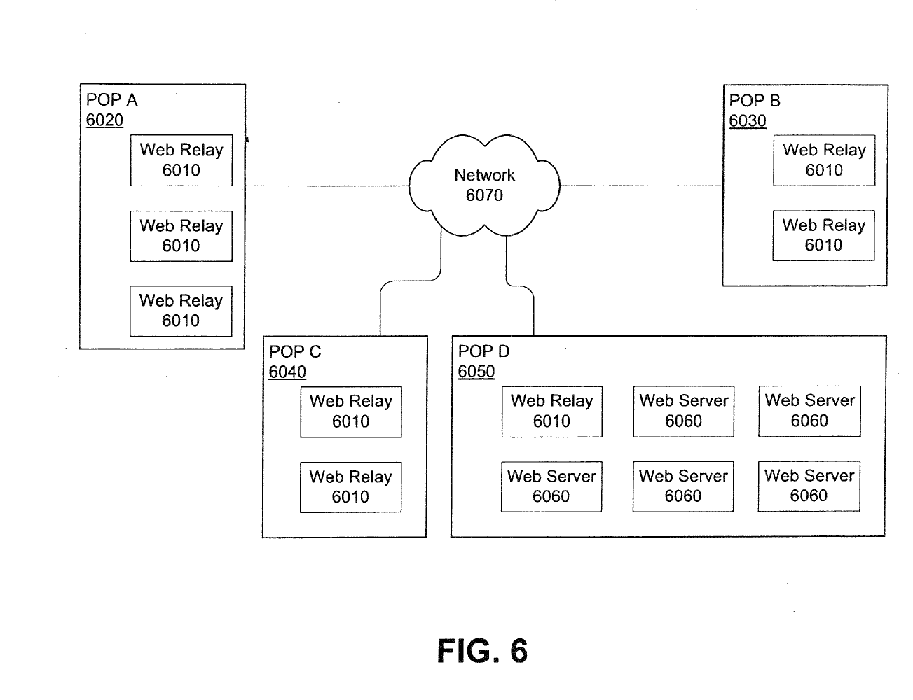

Referring to FIG. 6, web relays may be co-located in network backbone POPs where interconnections with major connectivity providers are terminated. Each content source included may be served by at least one web relay in each of the “backbone interconnection” POPs. Each web relay may provide service to multiple content sources, with the number deployed in each POP determined by the amount of requests that need to be handled for the sources served. In instances of popular content sources, one or more web relays in each POP may be dedicated to a single content source.

A typical ISP network includes many geographically distributed POPs with content-providing services located in one or more of the POPs. Some implementations include one or more web relays 6010 distributed through some or all of the POPs. For example, POP A 6020 includes three web relays 6010, POP B 6030 includes two web relays 6010, POP C 6040 includes two web relays, and POP D includes a single web relay 6010 and five web servers 6060. Each of the POPs are connected to network 6070. One or more of the web relays 6010 at each POP may be configured to relay information requests to one or more of the web servers 6060.

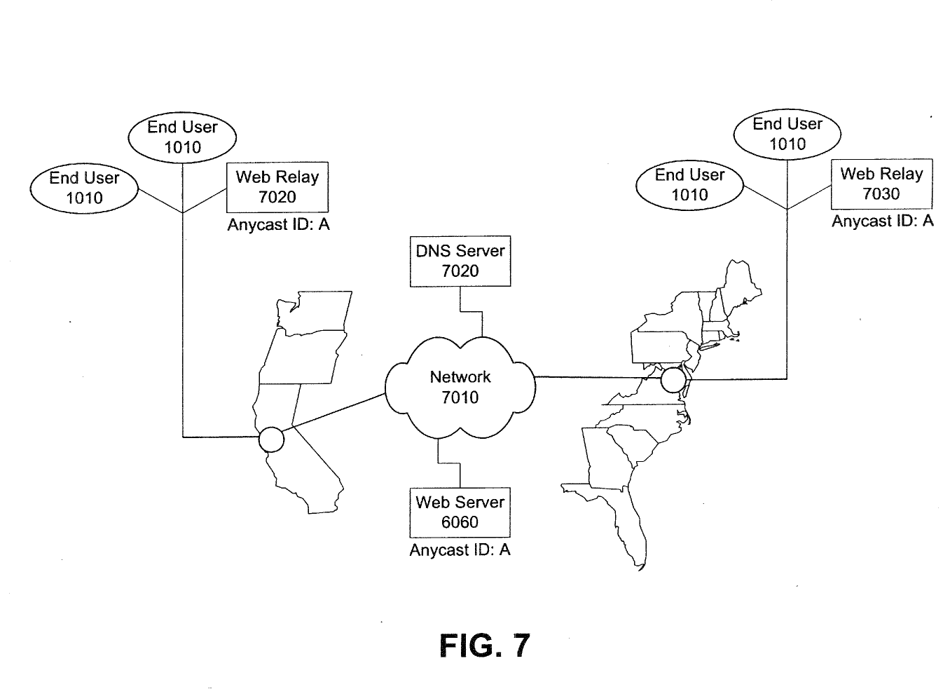

FIG. 7 illustrates an implementation of a system for scaling high-bandwidth data sources across a network infrastructure. The system includes a POP in San Jose and a POP in Washington, DC connected across a network 7010. The network includes a DNS server 7020 configured to return an anycast address in response to a query for web server 6060. In this example, DNS server 7020 returns an anycast address with a subnet corresponding to the ISP and an anycast identifier, such as “A”. An end user 1010 connected through the San Jose POP performs a DNS query to resolve the hostname of web server 6060. DNS server 7020 returns an anycast address served by web relay 7020 in San Jose and web relay 7030 in DC. Thus end users 1010 in San Jose would be routed to web relay 7020 and end users 1010 in DC would be routed to web relay 7030. Each web relay 7020 and 7030 forwards information queries to web server 6060, which sends a response back to the requesting web relay. The response is then returned by the web relay to end user 1010. If the web relays 7020 and 7030 also provide caching functionality, then the network traffic between web relays 7020 and 7030 and web server 6060 may be reduced.

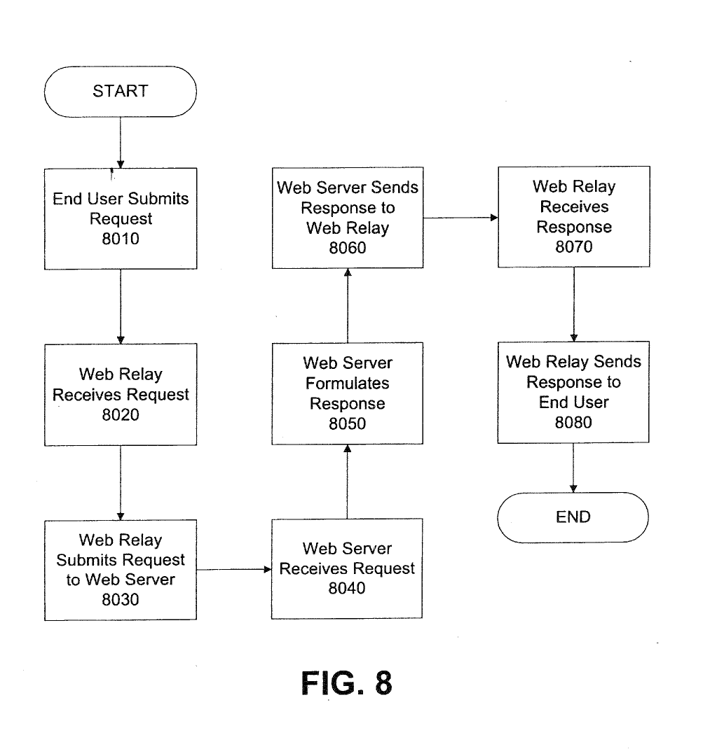

Referring to FIG. 8, an end user submits a request (step 8010) to the anycast address of a web server. A web relay, handling requests for the web server, receives the request (step 8020) and forwards the request to the web server (step 8030). The web server receives the request (step 8060 from the web relay and formulates a response (step 8050). The web server then sends the response to the web relay (step 8040). The web relay receives the response and forwards the response to the end user (step 8080).

Other implementations are within the scope of the following claims. For example, the implementations described above may equally be used to modify routing behavior at the local level or global level. The techniques are not limited to controlling routing across the country.

For example, the invention may be used for any network service, such as, the file transfer protocol (FTP), the simple mail transport protocol (SMTP), instant messaging, and gopher, in addition to controlling the routing of web traffic. In these implementations, “web relay” may be a misnomer, but the same principles can be applied.

What is claimed is:

1. A relay apparatus associated with a first Internet service provider (ISP) at a first point of presence (POP) in a first geographic area, wherein the first ISP includes a first remote POP in a second geographic area, the first POP and first remote POP in communication via a first wide area network (WAN) of the first ISP, the relay apparatus comprising:
an interface in communication with the first WAN of the first ISP;
a processor configured to receive a request from a second POP of a second ISP in the first geographic area, wherein the second ISP includes a second remote POP in the second geographic area, the second POP and the second remote POP in communication via a second WAN of the second ISP;
wherein the request is intended for a server at the first remote POP of the first ISP in the second geographic area;
wherein the processor is further configured to initiate transmission of the request to the server via the first WAN by identifying the relay apparatus as the source of the request; and
wherein identification of the relay apparatus as the source of the request inhibits the server from transmitting any responses to the request across the second WAN from the second remote POP to the second POP, and, instead, induces the server to transmit any responses to the request across the first WAN from the first remote POP to the first POP via the relay apparatus.

2. The relay apparatus as in claim 1, wherein the processor is further configured to receive a response to the request from the server across the first WAN and initiate transmission of the response from the first POP of the first ISP to the second POP of the second ISP in the first geographic area.

3. The relay apparatus as in claim 2, wherein the request is received from a user device in communication with the second POP of the second ISP in the first geographic area.

4. The relay apparatus as in claim 1 further comprising:
a domain name server (DNS) in the first geographic area configured to receive the request and identify an anycast address associated with the server to which the request is intended; and
wherein the DNS is further configured to initiate assignment of the anycast address associated with the server to the relay apparatus.

5. The relay apparatus as in claim 4, wherein the processor is configured to receive the request when the request is addressed to the anycast address of the server; and
wherein the processor is configured to initiate transmission of the request to the server by using a unicast address associated with the server.

6. The relay apparatus as in claim 4, wherein the anycast address assigned to the relay apparatus has a subnet portion corresponding to the first ISP.

7. The relay apparatus as in claim 1 further comprising a web cache for processing user requests intended for the server.

8. A method comprising:
at a first point of presence (POP) associated with a first Internet service provider (ISP), receiving a request from a second POP associated with a second ISP, wherein the first POP and the second POP are in a first geographic area;
wherein receiving the request includes identifying a server to which the request is intended, the server being at a first remote POP associated with the first ISP in a second geographic area, wherein the first POP and the first remote POP are in communication via a first wide area network (WAN) of the first ISP, and wherein the second ISP includes a second remote POP at the second geographic area, the second POP and the second remote POP in communication via a second WAN of the second ISP; and
modifying the request to specify an address of a relay device at the first POP as the source of the request, wherein modifying the request inhibits the server from transmitting any responses to the request across the second WAN from the second remote POP to the second POP, and, instead, induces the server to transmit any responses to the request across the first WAN from the first remote POP to the first POP via the relay apparatus.

9. The method as in claim 8 further comprising:
receiving a response to the request from the server across the first WAN; and
initiating transmission of the response from the first POP of the first ISP to the second POP of the second ISP in the first geographic area.

10. The method as in claim 9, wherein receiving the request further includes identifying a source of the request as a user device in communication with the second POP of the second ISP in the first geographic area.

11. The method as in claim 8 further comprising:
receiving an anycast address from a domain name server (DNS), the anycast address associated with the server to which the request is intended; and
associating the anycast address to an address of the relay device.

12. The method as in claim 11, wherein receiving the request further includes identifying a destination address of the request as the anycast address of the server; and
initiating transmission of the request to the server using a unicast address associated with the server as the destination address of the request.

13. The method as in claim 11 further comprising:
associating the anycast address to an address of the relay device to have a subnet portion corresponding to the first ISP.

14. The method as in claim 11 further comprising:
associating the anycast address to an address of a web cache.

15. A system comprising:
a first point of presence (POP) associated with a first Internet service provider (ISP) in a first geographic area, wherein the first POP is in communication with a first remote POP of the First ISP across a first wide area network (WAN) of the first ISP, the first remote POP located in a second geographic area;
a second (POP) associated with a second Internet service provider (ISP) in the first geographic area, wherein the second POP is in communication with a second remote POP of the second ISP across a second wide area network (WAN) of the second ISP, the second remote POP located in the second geographic area;
a server at the first remote POP of the first ISP in the second geographic area, the server configured to respond to requests from users of at least the first ISP and the second ISP;
at least one relay device configured to receive a request from the second POP of the second ISP in the first geographic area, wherein the request is intended for the server at the first remote POP of the first ISP in the second geographic area;
wherein the at least one relay device is further configured to initiate transmission of the request to the server via the first WAN by identifying the at least one relay device as the source or the request; and
wherein identification of the at least one relay device as the source of the request inhibits the server from transmitting any responses to the request across the second WAN from the second remote POP to the second POP, and, instead, induces the server to transmit any responses to the request across the first WAN from the first remote POP to the first POP via the relay device.

16. The system as in claim 15, wherein the at least one relay device receives a response to the request from the server across the first WAN and initiates transmission of the response from the first POP of the first ISP to the second POP of the second ISP in the first geographic area.

17. The system as in claim 16, wherein the request is received from a user device in communication with the second POP of the second ISP in the first geographic area.

18. The system as in claim 15 further comprising:
a domain name server (DNS) in the first geographic area configured to receive the request and identify an anycast address associated with the server to which the request is intended; and
wherein the DNS is further configured to initiate assignment of the anycast address associated with the server to the at least one relay device.

19. The system as in claim 18, wherein the at least one relay device receives the request when the request is addressed to the anycast address of the server; and
wherein the at least one relay device initiates transmission of the request to the server by using a unicast address associated with the server.

20. The system as in claim 18, wherein the anycast address assigned to the at least one relay device has a subnet portion corresponding to the first ISP.
